(19) United States
(12) Patent Application Publication
(10) Pub. No.: US 2026/0205417 A1
(43) Pub. Date: Jul. 16, 2026

(54) QUALITY OF SERVICE DETECTION METHOD AND APPARATUS, NODE DEVICE AND STORAGE MEDIUM

(71) Applicants: China Mobile Communication Co., Ltd Research Institute, Beijing (CN); China Mobile Communications Group Co., Ltd., Beijing (CN)

(72) Inventors: Xiaoqiu ZHANG, Beijing (CN); Weiqiang CHENG, Beijing (CN); Feng YANG, Beijing (CN); Wenying JIANG, Beijing (CN)

(21) Appl. No.: 19/136,383

(22) PCT Filed: Dec. 19, 2023
(86) PCT No.: PCT/CN2023/139780

§ 371 Date: Jun. 6, 2025

(30) Foreign Application Priority Data
Dec. 21, 2022 (CN) 202211650345.2

(51) Int. Cl. H04L 47/24; H04L 69/22

(52) U.S. Cl. CPC H04L 47/24; H04L 69/22

(57) ABSTRACT

Embodiments of this disclosure provide a quality of service detection method and apparatus, a node device and a storage medium. The method includes: after obtaining a transmission message of a target service flow, sending the transmission message to a service function (SF) node, and receiving a processed message resulting from a service processing performed by the SF node on the transmission message; in a case that a first node device obtains an enablement indication for performing quality detection on the SF node, detecting quality of service of the target service flow according to the transmission message sent to the SF node and the received processed message, to obtain quality detection data.

### CROSS-REFERENCE TO RELATED APPLICATION

This application claims priority to Chinese Patent Application No. 202211650345.2 filed in China on Dec. 21, 2022, the disclosure of which is incorporated herein by reference in its entirety.

### TECHNICAL FIELD

The present disclosure relates to the technical field of data communication networks, and in particular to a quality of service detection method and apparatus, a node device and a storage medium.

### BACKGROUND

Segment routing based on Internet Protocol version 6 (Segment Routing IPV6, SRv6) is a protocol designed based on the source routing concept to forward Internet Protocol Version 6 (IPv6) data packets on the network. Based on the IPV6 forwarding plane, SRv6 inserts a Segment Routing Header (SRH) into the IPV6 message, pushes an explicit IPV6 address stack into the SRH, and completes hop-by-hop forwarding by continuously updating the destination address and offset address stack by the intermediate nodes.

At present, in the service forwarding process based on IPv6 data packets, detection data are inserted into normal service traffic, the nodes of the service chain of service traffic transmission that are involved in the forwarding are triggered to collect relevant performance and statistical data based on the detection data in the traffic, and a centralized analyzer aggregates and analyzes the data obtained by the forwarding nodes, so as to obtain end-to-end and segment-by-segment performance data on the traffic forwarding path. However, this flow detection technology mainly performs segment-by-segment or end-to-end traffic quality detection on the traffic ingress and egress ports of the forwarding node device, and cannot achieve refined quality measurement of the service function (SF) node in the service chain, that is, to perform quality detection of packet loss, delay, etc. of the services transmitted by the service chain.

### SUMMARY

An objective of the present disclosure is to provide a quality of service detection method and apparatus, a node device and a storage medium, to achieve transmission quality detection of SF nodes in a service chain.

An embodiment of the present disclosure provides a quality of service detection method, which is performed by a first node device and includes:
after obtaining a transmission message of a target service flow, sending the transmission message to a service function (SF) node, and receiving a processed message resulting from a service processing performed by the SF node on the transmission message;
in a case that the first node device obtains an enablement indication for performing quality detection on the SF node, detecting quality of service of the target service flow according to the transmission message sent to the SF node and the received processed message to obtain quality detection data.

Optionally, the quality of service detection method further includes:
sending the quality detection data to a second node device.

Optionally, the detecting quality of service of the target service flow according to the transmission message sent to the SF node and the received processed message to obtain the quality detection data includes:
obtaining a first number of the transmission messages sent to the SF node within a preset period and first time information as to when the transmission messages are sent; and/or, obtaining a second number of the processed messages received within the preset period and second time information as to when the processed messages are received;
wherein the quality detection data includes one or more of the first number, the second number, the first time information and the second time information.

Optionally, the quality of service detection method further includes:
calculating a network transmission parameter based on the quality detection data.

Optionally, the quality of service detection method further includes:
parsing a detection flag in a segment routing header (SRH) of the transmission message;
in a case that the detection flag indicates that quality detection of the SF node is enabled, determining that the enablement indication is obtained.

Optionally, the quality of service detection method further includes:
obtaining a detection enablement configuration sent by a third node device;
determining, according to the detection enablement configuration, that the enablement indication for performing quality detection on the SF node is obtained.

Optionally, the parsing the detection flag in the segment routing header (SRH) of the transmission message includes:
in a case that it is identified that a function type field of a segment identifier (SID) in the SRH indicates a service chain function in a process of decapsulating the transmission message, parsing the detection flag in the SRH of the transmission message.

Optionally, the detection flag is logged in an argument field of the SID in the SRH.

Optionally, the detection flag includes first information for indicating whether the first node device is enabled to perform quality detection, and/or second information for indicating a detection type of quality detection.

An embodiment of the present disclosure further provides a quality of service detection method, which is performed by a third node device and includes:
sending a detection enablement configuration to at least one target node device; wherein the detection enablement configuration is used for configuring a first node device to perform quality detection on a connected SF node.

Optionally, the target node device includes the first node device and/or a fourth node device; the fourth node device is a head node of a service chain for target service flow transmission.

Optionally, the quality of service detection method further includes:
determining an SF node that needs to be quality-detected among multiple SF nodes through which the target service flow passes during transmission;
wherein, according to the determined SF node and the corresponding first node device, a detection enabling configuration is sent to the target node device.

Optionally, the determining the SF node that needs to be quality-detected among multiple SF nodes through which the target service flow passes during transmission includes:
determining the SF node that needs to be quality-detected among the multiple SF nodes through which the target service flow passes during transmission according to at least one of the following information:
a distribution position of each SF node through which the target service flow passes during transmission;
a service capability of each SF node through which the target service flow passes during transmission; or
an operation and maintenance requirement of a current network system.

Optionally, when the target node device includes the fourth node device, the sending the detection enablement configuration to at least one target node device includes:
sending a segment routing traffic engineering policy to the fourth node device, wherein the segment routing traffic engineering policy includes the detection enablement configuration.

Optionally, the detection enablement configuration includes an enablement indication for indicating whether to enable the first node device to perform quality detection on the connected SF node, and a type indication for indicating the detection type of the quality detection.

Optionally, the quality of service detection method further includes:
receiving quality detection data sent by the first node device;
calculating a network transmission parameter based on the quality detection data.

An embodiment of the present disclosure further provides a quality of service detection method, which is performed by a fourth node device and includes:
receiving a detection enabling configuration sent by a third node device; wherein the detection enabling configuration is used for configuring a first node device to perform quality detection on a connected SF node.

Optionally, the receiving the detection enablement configuration sent by the third node device includes:
receiving a segment routing traffic engineering policy sent by the third node device, wherein the segment routing traffic engineering policy includes the detection enabling configuration.

Optionally, the quality of service detection method further includes:
after obtaining an original message of a target service flow, redirecting and encapsulating the original message according to the segment routing traffic engineering policy to obtain a transmission message of the target service flow;
wherein an SRH of the transmission message includes a detection flag for instructing the first node device on a service chain of the transmission message to perform quality detection on the connected SF node.

Optionally, the detection flag is logged in an argument field of the SID in the SRH.

An embodiment of the present disclosure further provides a node device, wherein the node device is a first node device and includes a transceiver and a processor, wherein,
the transceiver is used for, after obtaining a transmission message of a target service flow, sending the transmission message to a service function (SF) node, and receiving a processed message resulting from a service processing performed by the SF node on the transmission message;
the processor is used for, in a case that the first node device obtains an enablement indication for performing quality detection on the SF node, detecting quality of service of the target service flow according to the transmission message sent to the SF node and the received processed message to obtain quality detection data.

An embodiment of the present disclosure further provides a node device, wherein the node device is a third node device and includes a transceiver, wherein the transceiver is used for sending a detection enablement configuration to at least one target node device; wherein the detection enablement configuration is used for configuring a first node device to perform quality detection on a connected SF node.

An embodiment of the present disclosure further provides a node device, wherein the node device is a fourth node device and includes a transceiver, wherein the transceiver is used for receiving a detection enabling configuration sent by a third node device; wherein the detection enabling configuration is used for configuring a first node device to perform quality detection on a connected SF node.

An embodiment of the present disclosure further provides a quality of service detection apparatus, which is applied to a first node device, and includes:
a transmission unit, configured to, after obtaining a transmission message of a target service flow, send the transmission message to a service function (SF) node, and receive a processed message resulting from a service processing performed by the SF node on the transmission message;
a detection unit, configured to, in a case that the first node device obtains an enablement indication for performing quality detection on the SF node, detect quality of service of the target service flow according to the transmission message sent to the SF node and the received processed message to obtain quality detection data.

An embodiment of the present disclosure further provides a quality of service detection apparatus, which is applied to a third node device, and includes:
a sending unit, configured to send a detection enabling configuration to at least one target node device; wherein the detection enabling configuration is used for configuring a first node device to perform quality detection on a connected SF node.

An embodiment of the present disclosure further provides a quality of service detection apparatus, which is applied to a fourth node device, and includes:
a receiving unit, configured to receive a detection enabling configuration sent by a third node device; wherein the detection enabling configuration is used for configuring a first node device to perform quality detection on a connected SF node.

An embodiment of the present disclosure further provides a node device, which includes: a processor, a memory, and a program stored in the memory and executable on the processor, wherein when the program is executed by the processor, any one of the foregoing quality of service detection methods is implemented.

An embodiment of the present disclosure further provides a readable storage medium, wherein a program is stored on the readable storage medium, and when the program is executed by a processor, the steps of any one of the foregoing quality of service detection methods are implemented.

At least one of the above technical solutions of the present disclosure has the following beneficial effects.

By adopting the quality of service detection method according to the embodiments of the present disclosure, the first node device on the service chain of the target service flow transmission can obtain an enablement indication for quality detection of the SF node, and according to the enablement indication, in the process of sending the transmission message to the service function (SF) node and receiving the processed message resulting from a service processing performed by the SF node on the transmission message, perform quality of service detection based on the transmission message sent to the SF node and the received processed message, so as to obtain quality detection data as a result of message transmission detection performed on the SF node.

### BRIEF DESCRIPTION OF THE DRAWINGS

FIG. 1 is a schematic diagram of the architecture of a system to which the quality of service detection method according to an embodiment of the present disclosure is applied;

FIG. 2 is a flow chart of a quality of service detection method according to a first embodiment of the present disclosure;

FIG. 3 is a schematic structural diagram of an IPV6 message according to an embodiment of the present disclosure;

FIG. 4 is a schematic structural diagram showing setting of a detection flag according to an embodiment of the present disclosure;

FIG. 5 is a flow chart of a quality of service detection method according to a second embodiment of the present disclosure;

FIG. 6 is a flow chart of a quality of service detection method according to a third embodiment of the present disclosure;

FIG. 7 is a schematic structural diagram of a node device according to a first embodiment of the present disclosure;

FIG. 8 is a schematic structural diagram of a node device according to a second embodiment of the present disclosure;

FIG. 9 is a schematic structural diagram of a node device according to a third embodiment of the present disclosure;

FIG. 10 is a schematic structural diagram of a quality of service detection apparatus according to the first embodiment of the present disclosure;

FIG. 11 is a schematic structural diagram of a quality of service detection apparatus according to the second embodiment of the present disclosure;

FIG. 12 is a schematic structural diagram of the quality of service detection apparatus according to the third embodiment of the present disclosure.

### DETAILED DESCRIPTION

In order to make the technical problems, technical solutions and advantages to be solved by the present disclosure more clear, a detailed description will be given below with reference to the accompanying drawings and specific embodiments.

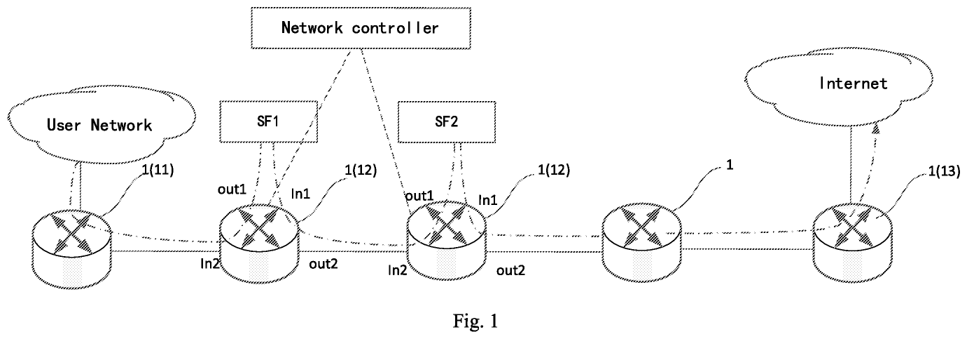

FIG. 1 is a schematic diagram of the architecture of a system to which the quality of service detection method according to an embodiment of the present disclosure is applied. The system is used for service flow transmission, and optionally for IPV6 data packet transmission. Specifically, the system is applied to a service function chain (SFC) to provide orderly services for the application layer. SFC is used for linking services on network devices at a logical level to form an orderly combination of services. SFC enables the message to pass through the service devices sequentially along a specified path by adding service chain path information to the original message.

When data packets are transmitted in the network, they often need to pass through various service nodes to ensure that the network can provide users with safe, fast and stable services according to a pre-determined plan. These service nodes include a firewall (FW), an intrusion prevention system (IPS), an application accelerator, and network address translation (NAT), etc. Network traffic needs to pass through these service nodes in an established order required by a service logic to achieve the required service.

In embodiments of the present disclosure, as shown in FIG. 1, a system for service data transmission according to the foregoing rules includes a plurality of node devices 1 (or network nodes), and the plurality of node devices 1 form a service chain for the service flow transmission. The plurality of node devices 1 include a head node 11, which may also be called a classifier (Service Classifier, SC), located in the transmission service chain. The head node 11 is used for receiving the original message (e.g., an IPV4 message) of the to-be-transmitted service flow from the user network, classifying the original message and redirecting it to the segment routing SRv6 Traffic Engineering (TE) policy, and encapsulating the original message and transmitting it to an intermediate node 12 (also called a forwarding node) of the service chain.

There is at least one intermediate node 12, each of which is connected to one service function (SF) node. Optionally, the SF node is used for implementing at least one of the functions such as a firewall, an intrusion firewall, and an application accelerator. The intermediate node 12 is used for receiving the transmission message transmitted by a previous node, decapsulating the transmission message, and sending the decapsulated transmission message to the connected SF node; after the SF node processes the received transmission message according to the corresponding function, the SF node sends the processed transmission message back to the connected intermediate node 12. The corresponding intermediate node inserts a segment routing header (SRH) into the received transmission message, pushes an explicit IPV6 address stack into the SRH, and transmits the transmission message to the next node device after performing SRv6 encapsulation of the transmission message. In this way, the hop-by-hop forwarding of the transmission message is completed by the intermediate node continuously updating the destination address and offset address stack.

In the embodiment of the present disclosure, optionally, the intermediate node 12 connected to the SF node can also be called a service function forwarder (SFF), or an SF that cannot recognize an SRv6 message (SRv6-unaware SF). The intermediate node 12 is configured with an SF proxy function, and the intermediate nodes 12 used for the SF proxy is assigned an SRv6 SID. The transmission service chain also includes a tail node 13, which is configured with a tail node SID, so that the classifier forms a segment list of an SRv6 TE Policy based on the Proxy SIDs of various intermediate nodes 12 and the tail node SID of the tail node, where the SRv6 TE Policy is a service chain path.

In order to solve the problem that the conventional flow detection technology mainly performs segment-by-segment or end-to-end quality detection of the traffic ingress and egress ports of the forwarding node device, and cannot achieve the refined quality measurement of the SF node in the service chain, embodiments of the present disclosure provide a quality of service detection method, in which the first node device on the service chain of the target service flow transmission can obtain an enablement indication for quality detection of the SF node, and according to the enablement indication, in the process of sending the transmission message to the service function (SF) node and receiving the processed message resulting from a service processing performed by the SF node on the transmission message, perform quality of service detection based on the transmission message sent to the SF node and the received processed message, so as to obtain quality detection data as a result of message transmission detection performed on the SF node.

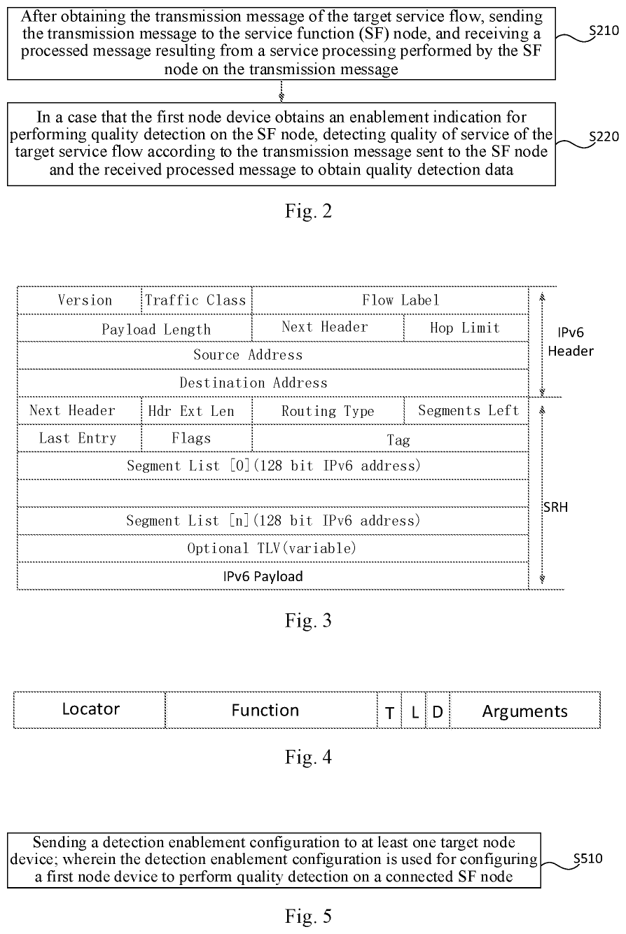

An embodiment of the present disclosure provides a quality of service detection method, which is performed by a first node device, as shown in FIG. 2, and includes:
S210, after obtaining the transmission message of the target service flow, sending the transmission message to the service function (SF) node, and receiving a processed message resulting from a service processing performed by the SF node on the transmission message;
S220: in a case that the first node device obtains an enablement indication for performing quality detection on the SF node, detecting quality of service of the target service flow according to the transmission message sent to the SF node and the received processed message to obtain quality detection data.

The first node device, the second node device, the third node device and the fourth node device mentioned in the embodiments of the present disclosure are only used for distinguishing different network nodes, and have nothing to do with the arrangement order of the network nodes on the service chain used for transmission of the target service flow.

Optionally, with reference to FIG. 1, the first node device is an intermediate node on a service chain for target service flow transmission, which may also be called SFF or SRv6-unaware SF, and is configured with SF Proxy function; the second node device and the third node device may be the same node device or different node devices, and are used for receiving the quality detection data reported by the first node device and performing detection enablement configuration; the fourth node device is the head node of the transmission service chain of the target service flow.

Optionally, the method further includes:
sending the quality detection data to a second node device.

Optionally, the quality detection data includes the number of lost packets and/or delay.

Optionally, the second node device may be a network controller. Through the method described in this embodiment, the first node device reports the quality detection data as a result of the service transmission quality detection performed on the SF node to the second node device, so that the second node device may calculate, based on the quality detection data, the number of lost packets and/or delay when the SF node performs service transmission, and adjust the network operation and maintenance based on the calculated number of lost packets and/or delay.

In another implementation, optionally, the method further includes:
calculating a network transmission parameter based on the quality detection data.

In this implementation, optionally, the first node device may directly calculate the number of lost packets and/or delay when the SF node performs service transmission according to the quality detection data as a result of the service transmission quality detection performed on the SF node.

Optionally, the first node device may also report the calculated network transmission parameters including the number of lost packets and/or delay to the second node device, so that the second node device may perform network operation and maintenance adjustments according to the network transmission parameters.

In an implementation of the present disclosure, optionally, the method further includes:
parsing a detection flag in a segment routing header (SRH) of the transmission message;
in a case that the detection flag indicates that the quality detection of the SF node is enabled, determining that the enablement indication is obtained. In this implementation, when the target service flow is transmitted on the service chain, a detection flag added to the SRH of the transmission message is used for instructing the first node device to perform quality detection on the connected SF node.

In another implementation of the present disclosure, the method further includes:
obtaining a detection enablement configuration sent by a third node device;
determining, according to the detection enablement configuration, that the enablement indication for performing quality detection on the SF node is obtained.

By adopting this implementation mode, the third node device can directly send a detection enablement configuration to the first node device, so that in the process of sending the transmission message of the target service flow to the SF node and receiving the processed message resulting from a service processing performed by the SF node on the transmission message, the first node device can perform quality of service detection of the target service flow transmitted by the SF node according to the detection enablement configuration obtained in advance.

In the embodiment of the present disclosure, with reference to FIG. 1, the third node device and the second node device may be different network nodes respectively, or may be the same network node, e.g., the network controller shown in FIG. 1.

Optionally, the third node device may perform the following step:
sending a detection enablement configuration to at least one target node device; wherein the detection enablement configuration is used for configuring a first node device to perform quality detection on a connected SF node.

The target node device is a node device on a service chain for target service flow transmission. Optionally, the target node device includes the first node device and/or a fourth node device; the fourth node device is a head node on a service chain for target service flow transmission.

Optionally, the method further includes:
the third node device determines the SF node that needs to be quality-detected among the multiple SF nodes through which the target service flow passes during transmission;
wherein the third node device sends a detection enablement configuration to the target node device according to the determined SF node and the corresponding first node device.

Optionally, that the third node device determines the SF node that needs to be quality-detected among the multiple SF nodes through which the target service flow passes during transmission includes:
the third node device determines, according to at least one of the following information, an SF node that needs to be quality-detected among the multiple SF nodes through which the target service flow passes during transmission:
a distribution position of each SF node through which the target service flow passes during transmission;
a service capability of each SF node through which the target service flow passes during transmission; or
an operation and maintenance requirement of a current network system.

Specifically, through the quality of service detection method described in this embodiment, a third node device (e.g., a network controller) collects the distribution position and/or service capability of each SF node in the network, and determines the SF node that needs to be quality-detected among multiple SF nodes based on the distribution positions and/or service capabilities, in combination with the needs of the service system, the operation and maintenance requirements of the current network system, etc., that is, enables the detection function for one or more SF nodes as needed.

In the embodiment of the present disclosure, optionally, that the third node device sends the detection enablement configuration to the fourth node device, that is, sends the detection enablement configuration to the head node on a service chain for target service flow transmission, includes:
the third node device sends a segment routing traffic engineering policy (SRv6 TE Policy) to the fourth node device, where the SRv6 TE Policy includes the detection enablement configuration.

Optionally, the network controller may send an SRv6 TE Policy to the head node SC through network configuration (Netconf) or the like, wherein the SRv6 TE Policy includes a detection enablement configuration for instructing the SFF (e.g., the first node device) connected to the determined SF node to perform quality detection on the corresponding SF node.

Optionally, the detection enablement configuration includes an enablement indication for indicating whether to enable the first node device to perform quality detection on the connected SF node, and a type indication for indicating a detection type of quality detection.

Specifically, the SFF SID corresponding to the first node device in the SRv6 TE Policy indicates whether the corresponding SF node needs to be quality-detected and the detection type of the required quality detection.

FIG. 3 is a schematic structural diagram of an IPV6 message in one implementation. The IPV6 message includes an IPV6 header and a segment routing header (SRH). The segment routing header (SRH) is used for carrying a sequence of SRv6 segment identifiers (SIDs), to achieve flexible programming of SRv6 network paths and various functions. SRH can also include an optional TLV field for carrying data of variable length, which provides better scalability for SRv6. The TLV field includes Tag (type), Length and Value.

SRv6 SID is used for identifying the ID of an SRv6 Segment, and includes a Locator field, a Function field and an Argument field. The Locator field is a variable-length part, and is an identifier assigned to a network node (e.g., the first node device) for routing and forwarding data packets and adapting to networks of different sizes. The Locator identifier has two important attributes: routable and aggregatable. The Function field is used for denoting the forwarding action to be performed by the instruction, which is equivalent to the opcode of a computer instruction. In SRv6 network programming, different forwarding behaviors are denoted by different respective Function fields. The Argument field is an optional field used for carrying the parameters required when executing the instruction, where these parameters may contain flow, service or any other related information.

In the embodiment of the present disclosure, the network controller sends an SRv6 TE Policy to the head node SC. The SRv6 TE Policy instructs, by means of a segment list, the devices in the network to forward by following the specified path. When a data packet is redirected to the SRv6 TE Policy, the segment list of the SRv6 TE Policy is added to the data packet by the head node, and intermediate node devices in the network system except the head node execute the instructions embedded in the segment list.

According to the above, through using the quality of service detection method described in the embodiment of the present disclosure, when the network controller sends the SRv6 TE Policy to the head node SC, the SRv6 SID segment list corresponding to the first node device also includes an enablement indication indicating whether quality detection of the connected SF node is enabled, and a type indication for indicating the detection type of the quality detection.

In another implementation of the present disclosure, the third node device (network controller) may also send the detection enablement configuration directly to the first node device, so that the first node device obtains the detection enablement configuration in advance, and can perform quality of service detection of the target service flow transmitted by the SF node according to the detection enablement configuration.

In an implementation of the present disclosure, the third node device (network controller) sends the detection enablement configuration to the fourth node device (head node), and optionally sends the detection enablement configuration to the fourth node device through the SRv6 TE Policy, so that after obtaining the original message of the target service flow, the fourth node device redirects and encapsulates the original message according to the detection enablement configuration and according to the segment routing traffic engineering policy, to obtain a transmission message of the target service flow;
wherein an SRH of the transmission message includes a detection flag for instructing the first node device on a service chain of the transmission message to perform quality detection on the connected SF node.

Specifically, the fourth node device (head node) receives the original message (e.g., an IPV4 message) of the target service flow from the user network, classifies the original message by matching classification information such as five-tuple, and redirects the classified message traffic to the SRv6 TE Policy. Further, the fourth node device (head node) performs SRv6 message encapsulation according to the SRv6 TE Policy, wherein the destination address of the encapsulated SRv6 message (transmission message) is the first forwarding node on the transmission service chain of the target service flow, that is, the SFF1 SID (SF1 Proxy SID) as shown in FIG. 1.

In the embodiment of the present disclosure, optionally, the first node device may be the first forwarding node on the transmission service chain of the target service flow, and of course, may also be any forwarding node.

In addition, when the fourth node device performs SRv6 message encapsulation, the fourth node device adds a detection flag to the segment routing header (SRH) of the encapsulated transmission message according to the detection enablement configuration sent by the network controller according to the SRv6 TE Policy, to instruct the first node device on the service chain of the transmission message to perform quality detection on the connected SF node.

Optionally, the detection flag is logged in an Argument field of an SID in the SRH.

In addition, optionally, the detection flag includes first information for indicating whether the first node device is enabled to perform quality detection, and/or second information for indicating a detection type of quality detection.

Optionally, the detection flag can include 3 bits, where 1 bit is used for indicating the first information, and 2 bits are used for indicating the second information. For example, the second information of “10” indicates that the detection type is packet loss detection, the second information of “01” indicates that the detection type is delay detection; the second information of “11” indicates that both packet loss detection and delay detection are performed. For example, as shown in FIG. 4, the T field in the Argument field is used for indicating the first information, and the L field and the D field are used for indicating the second information. L being set to 1 indicates packet loss detection, and D being set to 1 indicates delay detection.

It should be noted that the above-mentioned indication method of the detection flag is only for illustration and the present disclosure is not limited thereto.

According to the quality of service detection method described in the embodiment of the present disclosure, after obtaining the transmission message encapsulated as the SRv6 message, the first node device executes the instruction corresponding to the SFF SID in the SRH of the transmission message, to decapsulate the transmission message, and send the decapsulated transmission message to the corresponding SF node for processing.

Optionally, in the process of parsing the transmission message, when it is identified that the function type field of the SID in the SRH indicates a service chain function (e.g., End.AS), it is further detected whether the detection flag in the SRH of the transmission message, that is, the flag bit indicating the first information in the Argument field, is set to 1. If it is set to 1, it is determined that an enablement indication for quality detection of the SF node is obtained. In the case of obtaining the enablement indication, the detection type of the required detection is further obtained based on the flag bit indicating the second information in the Argument field. In this way, according to the detection flag, the flow detection process is started, that is, SF node detection is performed according to the data flow of the transmission message.

Optionally, the network node device further configures a preset period for performing SF node detection for the first node device, so that the first node device performs SF node detection according to the preset period.

In the embodiment of the present disclosure, optionally, with reference to FIG. 2, in step S220, detecting quality of service of the target service flow according to the transmission message sent to the SF node and the received processed message to obtain quality detection data includes:
obtaining a first number of the transmission messages sent to the SF node within a preset period and first time information as to when the transmission messages are sent; and/or, obtaining a second number of the processed messages received within the preset period and second time information as to when the processed messages are received;
wherein the quality detection data includes one or more of the first number, the second number, the first time information and the second time information.

Optionally, the first time information is obtained according to timestamp information of the transmission message, and the second time information is obtained according to timestamp information of the processed message.

Specifically, in the process of sending the transmission message to the service function (SF) node and receiving the processed message resulting from a service processing performed by the SF node on the transmission message, the first node device logs the first number Tx[i] and timestamp information t1 of the transmission messages sent to the SF node in the i-th preset period, and the second number Rx[i] and timestamp information t2 of the processed transmission messages sent by the SF node to the first node device in the i-th preset period.

For example, with reference to FIG. 1, the first node device may send a transmission message to the SF node through the out 1 interface between the first node and the SF node, and receive a processed message resulting from a service processing performed by the SF node on the transmission message through the In 1 interface between the first node and the SF node. Optionally, the out 1 interface and the In 1 interface may be the same interface or may be different interfaces.

By adopting this implementation, the service performance quality of message transmission of the SF node can be detected by counting and timing the messages transmitted through the out 1 interface and the In 1 interface.

In the embodiment of the present disclosure, the first node device may report the quality detection data obtained according to the above method to a network controller, e.g., the second node device or the third node device.

The network controller may calculate, based on the obtained quality detection data, a network transmission parameter, e.g., calculating the number of lost packets and/or delay of the transmission of transmission message.

For example, the network controller may calculate the number of lost packets and/or delay in the i-th preset period in the following manner:
the number of lost packets in the i-th preset period, namely, PacketLoss [i] is: PacketLoss [i]=Tx [i]−Rx [i];
the one-way transmission delay in the i-th preset period is: Delay [i]=t2−t1.

Optionally, the first node device may also directly calculate the network transmission parameter in the above manner according to the obtained quality detection data.

In the quality of service detection method according to the embodiment of the present disclosure, by performing message identification at the out 1 interface and the In 1 interface between the service function forwarder and the SF node, that is, performing message identification at the service function forwarder, the message whose Function field indicates the type of service chain function is identified, and further the service chain node quality detection is started according to the detection flag carried by the Argument field. Compared with the related art, by performing quality of service detection of message detection on the In 2 interface and the Out 2 interface on the service chain of the first node device, the method described in the embodiment of the present disclosure can achieve refined quality detection of the SF node and obtain the service transmission quality parameter such as packet loss and delay of the target service flow.

In the embodiment of the present disclosure, optionally, the method further includes:
the first node device sends the quality detection data to the second node device.

Optionally, the first node device reports a measurement (Telemetry) message to the second node device.

Optionally, the fourth node device (head node) reports the flow information shown in Table 1 below to the second node device (network controller), and identifies the transmission flow to which the transmission message belongs through FlowMonID.

In addition, when the first node device (forwarding network node) reports the Telemetry message to the network controller, the reported Telemetry message may include the content as shown in the following Table 2.

The network controller can determine the service which the logged quality detection data corresponds to based on the flow identifier (FlowMonID) (the special identifier is the service chain detection flow) in the Telemetry message reported by the first node device, and the node identifier (FlowNodeID) (the SFF can be determined through the locator information or pre-configured information) in the Telemetry message reported by the first node device, and perform corresponding calculation of delay and packet loss.

TABLE 1

| Reported | | |
|---|---|---|
| Information | Mandatory? | Description |
| FlowMonID | yes | Flow identifier |
| FlowNodeID | yes | Flow node identifier |
| Address Family | yes | Address type, IPv4 or IPv6 |
| Source IP | yes | Source IP address |
| Source IP | no | Source IP address mask length |
| Mask Length | | |
| Destination IP | yes | Destination IP address |
| Destination IP | no | Destination IP address mask length |
| Mask Length | | |
| Source Port | no | Source port number. 0 is an invalid |
| | | value. |
| Destination Port | no | Destination port number. 0 is an |
| | | invalid value. |
| Protocol | no | Protocol Number |
| VPN Name | no | VPN instance name |

TABLE 2

| Reported | | |
|---|---|---|
| Information | Mandatory? | Description |
| FlowMonID | yes | Flow identifier |
| FlowNodeID | yes | Flow node identifier (the SFF |
| | | can be determined through |
| | | locator information or pre- |
| | | configured information, to |
| | | determine the service which |
| | | the logged measurement |
| | | information corresponds to) |
| Direction | yes | Flow direction |
| | | 1—Ingress. |
| | | 2—Egress |
| IfName | yes | Ingress or egress interface name |
| PeriodID | yes | Period ID |
| Period | yes | Statistical periodicity, in units |
| | | of seconds. Its value is (1 s, |
| | | 10 s, 30 s, 60 s, 300 s) |
| PacketCount | no | Number of messages in a period |
| TimestampSecond | no | Integer part measured in |
| | | seconds of the time when |
| | | the delay measurement |
| | | message is received |
| TimestampNanoSecond | no | The remaining part measured |
| | | in nanoseconds |

In the embodiment of the present disclosure, the first node device, in the process of sending the transmission message to the service function (SF) node and receiving the processed message resulting from a service processing performed by the SF node on the transmission message, performs quality of service detection of the target service flow according to the transmission message sent to the SF node and the received processed message, to obtain the quality detection data.

Subsequently, the first node device searches for configuration information based on the Ingress interface (In 1 interface) information of the processed message; that is, the first node device searches for configuration information based on the In interface connected to the SF node that is used for receiving the IPV4 message, and adds SRH based on the found configuration information, and performs SRv6 encapsulation, wherein the destination address of the encapsulated transmission message is the address of the next forwarding node or tail node connected to the first node device on the service chain. For example, as shown in FIG. 1, when the first node device is SFF1, the next forwarding node is SFF2, and the destination address of the encapsulated transmission message is SF2 Proxy SID.

Taking the next forwarding node being SFF2 as an example, after SFF2 receives the transmission message, SFF2 executes the instruction corresponding to SF2 Proxy SID, decapsulates the message, and then sends the decapsulated original message to SF2 for processing. After SF2 processes the message, SF2 sends the message back to SFF2.

Similar to the first node device (SFF1), SFF2 performs quality of service detection on the target service flow transmitted through the SF2 node based on the transmission message sent to the SF2 node and the received processed message resulting from the service processing performed by the SF2 node on the transmission message, to obtains quality detection data, and sends the obtained quality detection data to the network controller.

The network controller may calculate, according to the quality detection data reported by the SFF2, the delay and the number of lost packets of the target service data transmitted by the SF2 node.

Furthermore, SFF2 searches for configuration information based on the Ingress interface (the interface of SFF that is connected to SF and used for receiving IPv4 messages) information of the message, and then adds SRH information based on the configuration and performs SRv6 encapsulation. At this time, the destination address of the SRv6 message is the Tail End SID. The message is forwarded to the Tail End node along the shortest interior gateway protocol (IGP) path.

In the embodiment of the present disclosure, for the specific implementation manner for SFF2 or any forwarding node to perform quality of service detection of the target service flow based on the transmission message sent to the SF node and the received processed message to obtain the quality detection data, references may be made to the detailed description of the first node device above, and repeated description will be omitted.

By adopting the quality of service detection method described in the embodiment of the present disclosure, the distribution positions and service capabilities of SFs in all network nodes are collected by the network controller, and the detection function of one or more SF nodes is arranged in the SRv6 SID list according to the demands from the service system or the requirements of network operation and maintenance. After the service function forwarder identifies the message as having a service chain function, the service chain node quality detection is started through the newly added detection flag in the SID Arg field, and the collected quality detection data is uploaded to the network controller through the Telemetry message, so that the network controller performs quality of service analysis (according to the service processing logic In-Out) to obtain measurement data. In this way, refined quality measurements such as packet loss and delay measurement can be achieved for each service in the service chain.

An embodiment of the present disclosure further provides a quality of service detection method, which is performed by a third node device, and, as shown in FIG. 5, includes:
S510, sending a detection enablement configuration to at least one target node device; wherein the detection enablement configuration is used for configuring a first node device to perform quality detection on a connected SF node.

By adopting the method according to the embodiment of the present disclosure, the third node device sends a detection enablement configuration for configuring the first node device to perform quality detection on the connected SF node to at least one target node device, so that the first node device on the service chain of the target service flow transmission can obtain an enablement indication for quality detection on the SF node, and according to the enablement indication, in the process of sending the transmission message to the service function (SF) node and receiving the processed message resulting from a service processing performed by the SF node on the transmission message, perform quality of service detection based on the transmission message sent to the SF node and the received processed message, so as to obtain quality detection data as a result of message transmission detection performed on the SF node.

Optionally, in the quality of service detection method, the target node device includes the first node device and/or a fourth node device; the fourth node device is the head node of a service chain for target service flow transmission.

Optionally, the quality of service detection method further includes:
determining an SF node that needs to be quality-detected among multiple SF nodes through which the target service flow passes during transmission;
wherein a detection enablement configuration is sent to the target node device according to the determined SF node and the corresponding first node device.

Optionally, in the quality of service detection method, the determining the SF node that needs to be quality-detected among multiple SF nodes through which the target service flow passes during transmission includes:
determining the SF node that needs to be quality-detected among the multiple SF nodes through which the target service flow passes during transmission according to at least one of the following information:
a distribution position of each SF node through which the target service flow passes during transmission;
a service capability of each SF node through which the target service flow passes during transmission;
an operation and maintenance requirement of a current network system.

Optionally, in the quality of service detection method, when the target node device includes the fourth node device, sending a detection enablement configuration to at least one target node device includes:
sending a segment routing traffic engineering policy to the fourth node device, wherein the segment routing traffic engineering policy includes the detection enablement configuration.

Optionally, in the quality of service detection method, the detection enablement configuration includes an enablement indication for indicating whether to enable the first node device to perform quality detection on the connected SF node, and a type indication for indicating the detection type of the quality detection.

Optionally, the quality of service detection method further includes:
receiving quality detection data sent by the first node device;
calculating a network transmission parameter based on the quality detection data.

For the specific implementation manner of applying the quality of service detection method according to the embodiment of the present disclosure to the third node device, references may be made to the detailed description of the manner of applying the method to the first node device, and repeated description will be omitted.

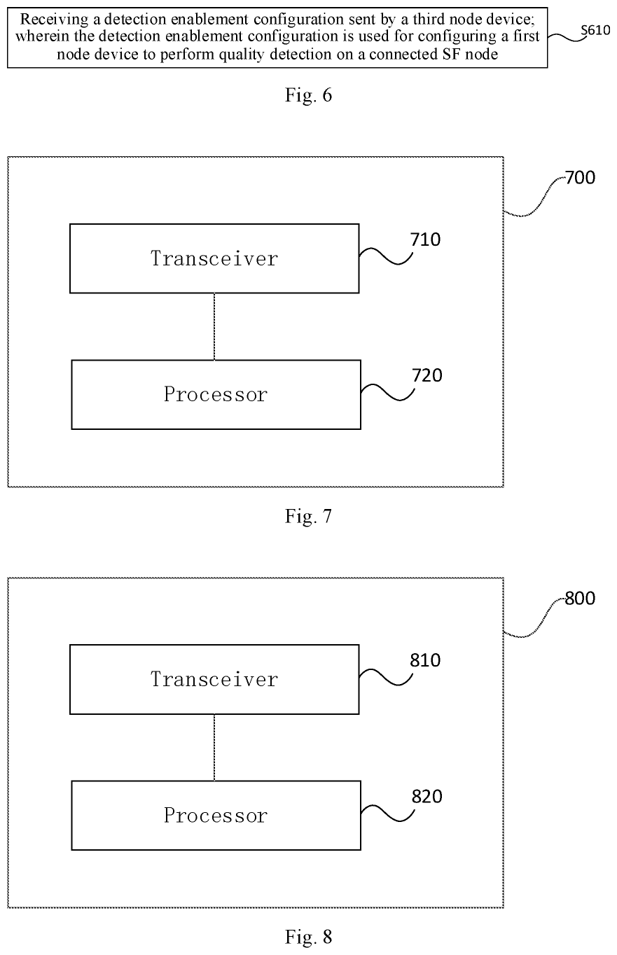

An embodiment of the present disclosure further provides a quality of service detection method, which is performed by a fourth node device, and, as shown in FIG. 6, includes:
S610: receiving a detection enablement configuration sent by a third node device; wherein the detection enablement configuration is used for configuring a first node device to perform quality detection on a connected SF node.

By adopting the service detection method described in the embodiment of the present disclosure, the third node device sends a detection enablement configuration for configuring the first node device to perform quality detection on the connected SF node to the fourth node device, so that the fourth node device can add a detection flag when transmitting the transmission message of the target service flow, and the first node device on the service chain of the target service flow transmission can obtain the detection flag, and according to the enablement indication, in the process of sending the transmission message to the service function (SF) node and receiving the processed message resulting from a service processing performed by the SF node on the transmission message, perform quality of service detection based on the transmission message sent to the SF node and the received processed message, so as to obtain quality detection data as a result of message transmission detection performed on the SF node.

Optionally, in the quality of service detection method, the receiving the detection enablement configuration sent by the third node device includes:
receiving a segment routing traffic engineering policy sent by the third node device, wherein the segment routing traffic engineering policy includes the detection enablement configuration.

Optionally, the quality of service detection method further includes:
after obtaining an original message of a target service flow, redirecting and encapsulating the original message according to the segment routing traffic engineering policy to obtain a transmission message of the target service flow;
wherein an SRH of the transmission message includes a detection flag for instructing the first node device on a service chain of the transmission message to perform quality detection on the connected SF node.

Optionally, in the quality of service detection method, the detection flag is logged in an argument field of the SID in the SRH.

An embodiment of the present disclosure further provides a node device, wherein the node device is a first node device. As shown in FIG. 7, the first node device 700 includes a transceiver 710 and a processor 720:
the transceiver 710 is used for, after obtaining a transmission message of a target service flow, sending the transmission message to a service function (SF) node, and receiving a processed message resulting from a service processing performed by the SF node on the transmission message;
the processor 720 is used for, in a case that the first node device obtains an enablement indication for performing quality detection on the SF node, detecting quality of service of the target service flow according to the transmission message sent to the SF node and the received processed message to obtain quality detection data.

Optionally, in the node device, the transceiver 710 is further used for:
sending the quality detection data to a second node device.

Optionally, the processor 720 detecting quality of service of the target service flow according to the transmission message sent to the SF node and the received processed message to obtain quality detection data includes:
obtaining a first number of the transmission messages sent to the SF node within a preset period and first time information as to when the transmission messages are sent; and/or, obtaining a second number of the processed messages received within the preset period and second time information as to when the processed messages are received;
wherein the quality detection data includes one or more of the first number, the second number, the first time information and the second time information.

Optionally, in the node device, the processor 720 is further used for:
calculating a network transmission parameter based on the quality detection data.

Optionally, in the node device, the processor 720 is further used for:
parsing a detection flag in a segment routing header (SRH) of the transmission message;
in a case that the detection flag indicates that quality detection of the SF node is enabled, determining that the enablement indication is obtained.

Optionally, in the node device, the processor 720 is further used for:
obtaining a detection enablement configuration sent by a third node device;
determining, according to the detection enablement configuration, that the enablement indication for performing quality detection on the SF node is obtained.

Optionally, in the node device, the processor 720 parsing a detection flag in the SRH of the transmission message includes:
in a case that it is identified that a function type field of a segment identifier (SID) in the SRH indicates a service chain function in a process of decapsulating the transmission message, parsing the detection flag in the SRH of the transmission message.

Optionally, in the node device, the detection flag is logged in an Argument field of a SID in the segment routing header (SRH).

Optionally, the detection flag includes first information for indicating whether the first node device is enabled to perform quality detection, and/or second information for indicating a detection type of quality detection.

Another embodiment of the present disclosure further provides a node device, wherein the node device is a third node device. As shown in FIG. 8, the third node device 800 includes a transceiver 810 and a processor 820, wherein the transceiver 810 is used for:
sending a detection enablement configuration to at least one target node device; wherein the detection enablement configuration is used for configuring a first node device to perform quality detection on a connected SF node.

Optionally, the target node device includes the first node device and/or a fourth node device; the fourth node device is a head node of a service chain for target service flow transmission.

Optionally, in the node device, the processor 820 is used for:
determining an SF node that needs to be quality-detected among multiple SF nodes through which the target service flow passes during transmission;
wherein the transceiver 810 sends a detection enablement configuration to the target node device according to the determined SF node and the corresponding first node device.

Optionally, the processor 820 determining the SF node that needs to be quality-detected among the multiple SF nodes through which the target service flow passes during transmission includes:
determining the SF node that needs to be quality-detected among the multiple SF nodes through which the target service flow passes during transmission according to at least one of the following information:
a distribution position of each SF node through which the target service flow passes during transmission;
a service capability of each SF node through which the target service flow passes during transmission; or
an operation and maintenance requirement of a current network system.

Optionally, when the target node device includes the fourth node device, the transceiver 810 sending the detection enablement configuration to at least one target node device includes:
sending a segment routing traffic engineering policy to the fourth node device, wherein the segment routing traffic engineering policy includes the detection enablement configuration.

Optionally, the detection enablement configuration includes an enablement indication for indicating whether to enable the first node device to perform quality detection on the connected SF node, and a type indication for indicating a detection type of quality detection.

Optionally, in the node device, the processor 820 is used for:
receiving quality detection data sent by the first node device;
calculating a network transmission parameter based on the quality detection data.

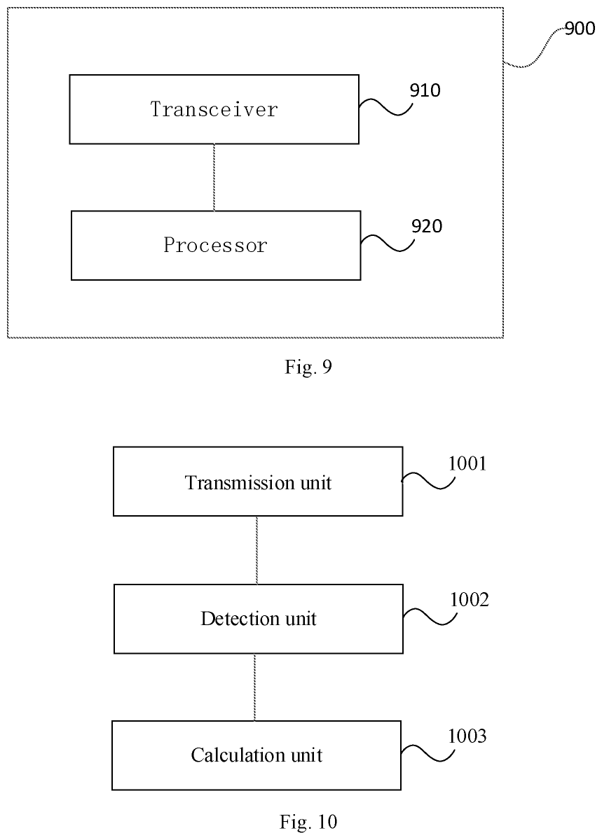

An embodiment of the present disclosure further provides a node device, wherein the node device is a fourth node device. As shown in FIG. 9, the fourth node device 900 includes a transceiver 910 and a processor 920, wherein the transceiver 910 is used for:
receiving a detection enablement configuration sent by a third node device; wherein the detection enablement configuration is used for configuring a first node device to perform quality detection on a connected SF node.

Optionally, the transceiver 910 receiving the detection enablement configuration sent by the third node device includes:
receiving a segment routing traffic engineering policy sent by the third node device, wherein the segment routing traffic engineering policy includes the detection enablement configuration.

Optionally, in the node device, the processor 920 is used for:
after obtaining an original message of a target service flow, redirecting and encapsulating the original message according to the segment routing traffic engineering policy to obtain a transmission message of the target service flow;
wherein an SRH of the transmission message includes a detection flag for instructing the first node device on a service chain of the transmission message to perform quality detection on the connected SF node.

Optionally, the detection flag is logged in a Argument field of an SID in the segment routing header (SRH).

An embodiment of the present disclosure further provides a quality of service detection apparatus, which is applied to a first node device. As shown in FIG. 10, the apparatus includes:
a transmission unit 1001, configured to, after obtaining a transmission message of a target service flow, send the transmission message to a service function (SF) node, and receive a processed message resulting from a service processing performed by the SF node on the transmission message;
a detection unit 1002, configured to, in a case that the first node device obtains an enablement indication for performing quality detection on the SF node, detect quality of service of the target service flow according to the transmission message sent to the SF node and the received processed message to obtain quality detection data.

Optionally, in the quality of service detection apparatus, the transmission unit 1001 is further configured to:
send the quality detection data to a second node device.

Optionally, the detection unit 1002 detecting quality of service of the target service flow according to the transmission message sent to the SF node and the received processed message to obtain quality detection data includes:
obtaining a first number of the transmission messages sent to the SF node within a preset period and first time information as to when the transmission messages are sent; and/or, obtaining a second number of the processed messages received within the preset period and second time information as to when the processed messages are received;
wherein the quality detection data includes one or more of the first number, the second number, the first time information and the second time information.

Optionally, the quality of service detection apparatus further includes:
a calculation unit 1003, configured to calculate a network transmission parameter according to the quality detection data.

Optionally, in the quality of service detection apparatus, the detection unit 1002 is further configured to:
parse a detection flag in a segment routing header (SRH) of the transmission message;
in a case that the detection flag indicates that quality detection of the SF node is enabled, determine that the enablement indication is obtained.

Optionally, in the quality of service detection apparatus, the detection unit 1002 is further configured to:
obtain a detection enablement configuration sent by a third node device;
determine, according to the detection enablement configuration, that the enablement indication for performing quality detection on the SF node is obtained.

Optionally, in the quality of service detection apparatus, the detection unit 1002 parsing the detection flag in the SRH of the transmission message includes:
in a case that it is identified that a function type field of a segment identifier (SID) in the SRH indicates a service chain function in a process of decapsulating the transmission message, parsing the detection flag in the SRH of the transmission message.

Optionally, the detection flag is logged in an argument field of a segment identifier (SID) in the segment routing header (SRH).

Optionally, the detection flag includes first information for indicating whether the first node device is enabled to perform quality detection, and/or second information for indicating a detection type of quality detection.

An embodiment of the present disclosure further provides a quality of service detection apparatus, which is applied to a third node device. As shown in FIG. 11, the apparatus includes:
a sending unit 1101, configured to send a detection enablement configuration to at least one target node device; wherein the detection enablement configuration is used for configuring a first node device to perform quality detection on a connected SF node.

Optionally, the target node device includes the first node device and/or a fourth node device; the fourth node device is a head node of a service chain for target service flow transmission.

Optionally, the quality of service detection apparatus further includes:
a determining unit 1102, configured to determine the SF node that needs to be quality-detected among the multiple SF nodes through which the target service flow passes during transmission;
wherein the sending unit 1101 sends the detection enablement configuration to the target node device according to the determined SF node and the corresponding first node device.

Optionally, the determining unit 1102 determining the SF node that needs to be quality-detected among the multiple SF nodes through which the target service flow passes during transmission includes:
determining the SF node that needs to be quality-detected among the multiple SF nodes through which the target service flow passes during transmission according to at least one of the following information:
a distribution position of each SF node through which the target service flow passes during transmission;
a service capability of each SF node through which the target service flow passes during transmission; or
an operation and maintenance requirement of a current network system.

Optionally, when the target node device includes the fourth node device, the sending unit 1101 sending the detection enablement configuration to at least one target node device includes:
sending a segment routing traffic engineering policy to the fourth node device, wherein the segment routing traffic engineering policy includes the detection enablement configuration.

Optionally, the detection enablement configuration includes an enablement indication for indicating whether to enable the first node device to perform quality detection on the connected SF node, and a type indication for indicating a detection type of quality detection.

Optionally, the quality of service detection apparatus further includes:
a receiving unit 1103, configured to receive quality detection data sent by the first node device;
a calculation unit 1104, configured to calculate a network transmission parameter according to the quality detection data.

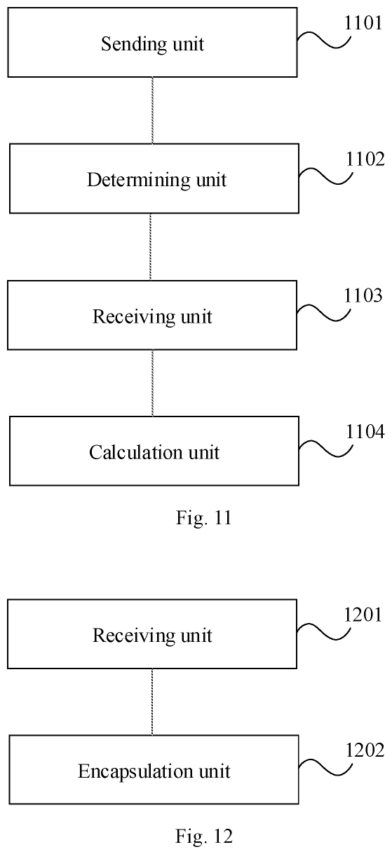

An embodiment of the present disclosure further provides a quality of service detection apparatus, which is applied to a fourth node device. As shown in FIG. 12, the apparatus includes:
a receiving unit 1201, configured to receive a detection enablement configuration sent by a third node device, wherein the detection enablement configuration is used for configuring a first node device to perform quality detection on a connected SF node.

Optionally, the receiving unit 1201 receiving the detection enablement configuration sent by the third node device includes:
receiving a segment routing traffic engineering policy sent by the third node device, wherein the segment routing traffic engineering policy includes the detection enablement configuration.

Optionally, the quality of service detection apparatus further includes:
an encapsulation unit 1202, configured to redirect and encapsulate the original message according to the segment routing traffic engineering policy after obtaining the original message of the target service flow, so as to obtain the transmission message of the target service flow;
wherein an SRH of the transmission message includes a detection flag for instructing the first node device on a service chain of the transmission message to perform quality detection on the connected SF node.

Optionally, the detection flag is logged in an argument field of a segment identifier (SID) in the segment routing header (SRH).

An embodiment of the present disclosure also provides a node device, including: a processor, a memory, and a program stored in the memory and executable on the processor, wherein when the program is executed by the processor, any one of the aforementioned quality of service detection methods is implemented.

The node device may be any one of the first node device, the second node device and the fourth node device mentioned above. For the specific implementation manner for the processor of the corresponding node device to implement the quality of service detection method described in the embodiment of the present disclosure, references may be made to the above detailed description, and repeated description will be omitted.

In addition, a specific embodiment of the present disclosure further provides a readable storage medium on which a computer program is stored, wherein when the program is executed by a processor, the steps in any one of the aforementioned quality of service detection methods are implemented.

Specifically, the readable storage medium is applied to the above-mentioned node device. When applied to the node device, references may be made to the execution steps in the corresponding quality of service detection method described above, and repeated description will be omitted.

In the embodiments provided in the present disclosure, it should be understood that the disclosed methods and apparatuses can be implemented in other ways. For example, the apparatus embodiments described above are only illustrative. For example, the division of the units is only a logical function division. There may be other division methods in actual implementation, such as multiple units or components can be combined or integrated into another system, or some features can be ignored or not executed. Additionally, the mutual coupling or direct coupling or communication connection shown or discussed can be an indirect coupling or communication connection through some interfaces, apparatuses or units, which can be electrical, mechanical or other forms.

In addition, each functional unit in the embodiments of the present disclosure may be integrated into one processing unit, or each unit may be physically separate, or two or more units may be integrated into one unit. The above-mentioned integrated unit may be implemented in the form of hardware or in the form of hardware plus software functional units.

The above-mentioned integrated unit implemented in the form of a software functional unit can be stored in a computer-readable storage medium. The above-mentioned software functional unit is stored in a storage medium, including a number of instructions for a computer device (which can be a personal computer, a server, or a network device, etc.) to perform some steps of the sending and receiving method described in the embodiments of the present disclosure. The aforementioned storage medium includes: U disk, mobile hard disk, read-only memory (ROM), random access memory (RAM), magnetic disk or optical disc and other media that can store program codes.

The above is optional embodiments of the present disclosure. It should be pointed out that, several improvements and modifications can be made by those of ordinary skill in the art without departing from the principles described in the present disclosure. These improvements and modifications should also be regarded as falling within the scope of the present disclosure.

1. A quality of service detection method, performed by a first node device, comprising:
after obtaining a transmission message of a target service flow, sending the transmission message to a service function (SF) node, and receiving a processed message resulting from a service processing performed by the SF node on the transmission message;
in a case that the first node device obtains an enablement indication for performing quality detection on the SF node, detecting quality of service of the target service flow according to the transmission message sent to the SF node and the received processed message to obtain quality detection data.

2. The quality of service detection method according to claim 1, further comprising:
sending the quality detection data to a second node device.

3. The quality of service detection method according to claim 1, wherein the detecting quality of service of the target service flow according to the transmission message sent to the SF node and the received processed message to obtain the quality detection data comprises:
obtaining a first number of the transmission messages sent to the SF node within a preset period and first time information as to when the transmission messages are sent; and/or, obtaining a second number of the processed messages received within the preset period and second time information as to when the processed messages are received;
wherein the quality detection data comprises one or more of the first number, the second number, the first time information and the second time information;
or,
wherein the method further comprises:
calculating a network transmission parameter based on the quality detection data;
or,
wherein the method further comprises:
obtaining a detection enablement configuration sent by a third node device;
determining, according to the detection enablement configuration, that the enablement indication for performing quality detection on the SF node is obtained.

4. (canceled)

5. The quality of service detection method according to claim 1, further comprising:
parsing a detection flag in a segment routing header (SRH) of the transmission message;
in a case that the detection flag indicates that quality detection of the SF node is enabled, determining that the enablement indication is obtained.

6. (canceled)

7. The quality of service detection method according to claim 5, wherein the parsing the detection flag in the SRH of the transmission message comprises:
in a case that it is identified that a function type field of a segment identifier (SID) in the SRH indicates a service chain function in a process of decapsulating the transmission message, parsing the detection flag in the SRH of the transmission message.

8. The quality of service detection method according to claim 7, wherein the detection flag is logged in an argument field of the SID in the SRH.

9. The quality of service detection method according to claim 5, wherein the detection flag comprises first information for indicating whether the first node device is enabled to perform quality detection, and/or second information for indicating a detection type of quality detection.

10. A quality of service detection method, performed by a third node device, comprising:
sending a detection enablement configuration to at least one target node device; wherein the detection enablement configuration is used for configuring a first node device to perform quality detection on a connected SF node.

11. The quality of service detection method according to claim 10, wherein the target node device comprises the first node device and/or a fourth node device; the fourth node device is a head node of a service chain for target service flow transmission.

12. The quality of service detection method according to claim 10, further comprising:
determining an SF node that needs to be quality-detected among multiple SF nodes through which the target service flow passes during transmission;
wherein, according to the determined SF node and the corresponding first node device, a detection enablement configuration is sent to the target node device.

13. The quality of service detection method according to claim 12, wherein the determining the SF node that needs to be quality-detected among the multiple SF nodes through which the target service flow passes during transmission comprises:
determining the SF node that needs to be quality-detected among the multiple SF nodes through which the target service flow passes during transmission according to at least one of the following information:
a distribution position of each SF node through which the target service flow passes during transmission;
a service capability of each SF node through which the target service flow passes during transmission; or
an operation and maintenance requirement of a current network system.

14. The quality of service detection method according to claim 11, wherein in a case that the target node device comprises the fourth node device, the sending the detection enablement configuration to the at least one target node device comprises:
sending a segment routing traffic engineering policy to the fourth node device, wherein the segment routing traffic engineering policy comprises the detection enablement configuration.

15. The quality of service detection method according to claim 10, wherein the detection enablement configuration comprises an enablement indication for indicating whether to enable the first node device to perform quality detection on the connected SF node, and a type indication for indicating a detection type of quality detection;
or,
wherein the method further comprises:
receiving quality detection data sent by the first node device;
calculating a network transmission parameter based on the quality detection data.

16. (canceled)

17. A quality of service detection method, performed by a fourth node device, comprising:
receiving a detection enablement configuration sent by a third node device; wherein the detection enablement configuration is used for configuring a first node device to perform quality detection on a connected SF node.

18. The quality of service detection method according to claim 17, wherein the receiving the detection enablement configuration sent by the third node device comprises:
receiving a segment routing traffic engineering policy sent by the third node device, wherein the segment routing traffic engineering policy comprises the detection enablement configuration.

19. The quality of service detection method according to claim 18, further comprising:
after obtaining an original message of a target service flow, redirecting and encapsulating the original message according to the segment routing traffic engineering policy to obtain a transmission message of the target service flow;
wherein a segment routing header (SRH) of the transmission message comprises a detection flag for instructing the first node device on a service chain of the transmission message to perform quality detection on the connected SF node.

20. The quality of service detection method according to claim 19, wherein the detection flag is logged in an argument field of a segment identifier (SID) in the SRH.

21-26. (canceled)

27. A node device, comprising: a processor, a memory, and a program stored in the memory and executable on the processor, wherein when the program is executed by the processor, the quality of service detection method according to claim 1 is implemented.

28. (canceled)

29. A node device, comprising: a processor, a memory, and a program stored in the memory and executable on the processor, wherein when the program is executed by the processor, the quality of service detection method according to claim 10 is implemented.

30. A node device, comprising: a processor, a memory, and a program stored in the memory and executable on the processor, wherein when the program is executed by the processor, the quality of service detection method according to claim 17 is implemented.
